(19) United States
(12) Patent Application Publication
(10) Pub. No.: US 2010/0067256 A1
(43) Pub. Date: Mar. 18, 2010

(54) LIGHT SOURCE SET AND BACK LIGHT MODULE

(75) Inventor: Chia-Chun Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taoyuan (TW)

(21) Appl. No.: 12/326,912

(22) Filed: Dec. 3, 2008

(30) Foreign Application Priority Data
Sep. 15, 2008 (TW) 97135342

(51) Int. Cl. F21V 7/22; B60Q 1/26

(52) U.S. Cl. 362/615; 362/227

(57) ABSTRACT

A light source set including a light cover has an opening, a first side and a second side, a first circuit board disposed on the first side, a plurality of first point light sources disposed on the first circuit board, a second circuit board disposed on the second side and a plurality of second point light sources disposed on the second circuit board is provided. The first side and the second side are located at two opposite sides of the opening. Each first point light source has a first light-emitting surface facing to the opening and a first top surface departing from the first circuit board. Each second point light source has a second light-emitting surface facing to the opening. A distance between the first top surface and the second circuit board is smaller than a height of the second point light sources.

### CROSS-REFERENCE TO RELATED APPLICATION

This application claims the priority benefit of Taiwan application serial no. 97135342, filed on Sep. 15, 2008. The entirety of the above-mentioned patent application is hereby incorporated by reference herein and made a part of this specification.

### BACKGROUND OF THE INVENTION

1. Field of the Invention

The present invention relates to a light source set and a backlight module. More particularly, the present invention relates to a light source set and a backlight module having point light sources disposed on different circuit boards.

2. Description of Related Art

With great improvement of computer performance and quick development of Internet and multimedia techniques, transmission of image information is changed from analog transmission to digital transmission. To comply with a modern life, sizes of video or image devices are gradually lighter and thinner. Though a conventional cathode ray tube (CRT) display still has its own advantages, it has an excessive size and occupies a relatively great space due to an internal electron beam gun structure thereof, and the CRT also has a radiation problem during displaying. Therefore, flat panel displays such as liquid crystal displays (LCDs), organic light emission displays (OLEDs) or plasma display panels (PDPs) developed based on photoelectric technology and semiconductor fabrication technology gradually become popular in the market.

For the LCD, display medium thereof is none self-luminescent liquid crystal molecules. Therefore, the LCD is mainly formed by an LCD panel and a backlight module, wherein the backlight module is used for providing a planar light source required by the LCD panel, so as to achieve a display effect of the LCD. In the backlight module, light-emitting diodes (LEDs) having features of small size, low power consumption, good light-emitting directivity and high luminescent efficiency generally serve as the light sources.

However, the point-distributed LED light sources may have a problem of uneven light source distribution. Moreover, suitable circuit layout spaces have to be maintained among the LEDs, so that a distribution density thereof cannot be improved, and therefore light source brightness cannot be increased according to utilization requirements.

### SUMMARY OF THE INVENTION

The present invention is directed to a light source set, which can improve a distribution density of LEDs.

The present invention is directed to a backlight module, which can resolve a problem that a distribution density of LEDs within a conventional backlight module cannot be improved.

The present invention provides a light source set including a light cover, a first circuit board, a plurality of first point light sources, a second circuit board and a plurality of second point light sources. The light cover has an opening, a first side and a second side. The first side and the second side are located at two opposite sides of the opening. The first circuit board is disposed on the first side. The first point light sources are disposed on the first circuit board, and each first point light source has a first light-emitting surface facing to the opening and a first top surface departing from the first circuit board. The second circuit board is disposed on the second side, and is substantially parallel to the first circuit board. The second point light sources are disposed on the second circuit board, and each second point light source has a second light-emitting surface facing to the opening. A distance between the first top surface and the second circuit board is smaller than a height of the second point light sources.

The present invention provides a backlight module including a light source set, a light-guiding plate and a reflecting plate. The light source set includes a light cover, a first circuit board, a plurality of first point light sources, a second circuit board and a plurality of second point light sources. The light cover has an opening, a first side and a second side. The first side and the second side are located at two opposite sides of the opening. The first circuit board is disposed on the first side. The first point light sources are disposed on the first circuit board, and each first point light source has a first light-emitting surface facing to the opening and a first top surface departing from the first circuit board. The second circuit board is disposed on the second side, and is substantially parallel to the first circuit board. The second point light sources are disposed on the second circuit board, and each second point light source has a second light-emitting surface facing to the opening. A distance between the first top surface and the second circuit board is smaller than a height of the second point light sources. The light-guiding plate is disposed aside the opening, and has a light-outlet surface and a light-incident surface located adjacent to the light-outlet surface, wherein the light-incident surface faces the opening. The reflecting plate is disposed on a side of the light-guiding plate departing from the light-outlet surface.

In an embodiment of the present invention, the first point light sources are arranged along a first line, and the second point light sources are arranged along a second line, wherein the first line and the second line are parallel to an extending direction of the first circuit board. The first line is for example overlapped to the second line, or the first line is located between the second line and the opening.

In an embodiment of the present invention, quantity of the first point light sources is equal to that of the second point light sources.

In an embodiment of the present invention, quantity of the first point light sources is greater than or less than that of the second point light sources.

In an embodiment of the present invention, the light source set further includes a connecting circuit board coupled between the first circuit board and the second circuit board. The first circuit board, the second circuit board and the connecting circuit board are integrally formed. The connecting circuit board is disposed adjacent to the opening. Alternatively, the connecting circuit board is disposed opposite to the opening. If the connecting circuit board is disposed opposite to the opening, a width of the connecting circuit board can be equal to or less than that of the first circuit board along the extending direction of the first circuit board. The connecting circuit board includes a plurality of sub-connecting circuit boards, and a width of each sub-connecting circuit board is less than that of the first circuit board along the extending direction of the first circuit board.

In an embodiment of the present invention, the backlight module further includes a plurality of optical films disposed on the light-outlet surface of the light-guiding plate.

In an embodiment of the present invention, the first point light source and the second point light source are for example, a plurality of LEDs.

In the present invention, the point light sources are disposed on two opposite circuit boards, so that the disposing density of the point light sources can be increased according to different design requirements without being limited by the circuit layout spaces within the light source set. In other words, the point light sources with high disposing density can be applied to the light source set and the backlight module of the present invention according to different design requirements, so as to achieve a better light-emitting effect. Moreover, in the light source set and the backlight module of the present invention, the point light sources are not mutually overlapped, which avails thinning the light source set and the backlight module.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a light source set according to an embodiment of the present invention.

FIG. 2A and FIG. 2B are diagrams illustrating two configuration relations of first point light sources and second point light sources viewing from a first side to a second side of the light cover within a light source set of FIG. 1.

FIG. 2C is a diagram illustrating a configuration relation of first point light sources and second point light sources viewing from a first side to a second side of the light cover within a light source set according to another embodiment of the present invention.

FIG. 3 is a cross-sectional view of a backlight module according to an embodiment of the present invention.

FIG. 4A and FIG. 4B are schematic diagrams illustrating point light sources and a flexible circuit board according to an embodiment of the present invention.

FIG. 5A and FIG. 5B are schematic diagrams illustrating point light sources and circuit boards according to another embodiment of the present invention.

FIG. 5C and FIG. 5D are schematic diagrams illustrating circuit boards and point light sources according to other embodiments of the present invention.

### DESCRIPTION OF EMBODIMENTS

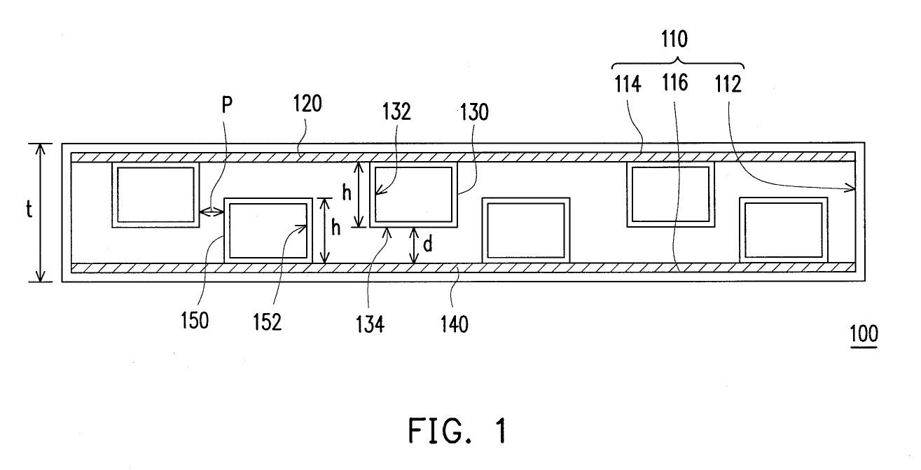

FIG. 1 is a schematic diagram illustrating a light source set according to an embodiment of the present invention. Referring to FIG. 1, the light source set 100 includes a light cover 110, a first circuit board 120, a plurality of first point light sources 130, a second circuit board 140 and a plurality of second point light sources 150. The light cover 110 has an opening 112, a first side 114 and a second side 116. The first side 114 and the second side 116 are located at two opposite sides of the opening 112. The first circuit board 120 is disposed on the first side 114. The first point light sources 130 are disposed on the first circuit board 120, and each first point light source 130 has a first light-emitting surface 132 facing to the opening 112 and a first top surface 134 surface 134 departing from the first circuit board 120. The second circuit board 140 is disposed on the second side 116, and is substantially parallel to the first circuit board 120. The second point light sources 150 are disposed on the second circuit board 140, and each second point light source 150 has a second light-emitting surface 152 facing to the opening 112.

It should be noted that a distance d between the first top surface 134 of the first point light source 130 and the second circuit board 140 is smaller than a height h of the second point light sources 150. Moreover, the first point light sources 130 and the second point light sources 150 are for example formed by a plurality of LEDs. If the first point light source 130 and the second point light source 150 have the same specification, a thickness t of the light source set 100 is approximately a sum of the height h of the point light source and the distance d. The distance d can be reduced according to different design requirements, so that the thickness t of the light source set 100 can be further reduced to comply with a requirement of thin and slim.

Value of the distance d is not limited by the present embodiment. To thin the light source set 100, the distance d can be reduced to approaching zero. Namely, the first point light sources 130 and the second point light sources 150 can be approximately disposed between the first circuit board 120 and the second circuit board 140. Accordingly, the thickness t of the light source set 100 only equals to a height of one LED, approximately.

Moreover, to make a light-emitting effect of the point light sources close to that of a linear light source, the point light sources of the light source set 100 are usually closely arranged. However, on a same circuit board, suitable spaces has to be maintained among the point light sources to avoid a short circuit of the point light sources. Therefore, densely arranging the point light sources on the same circuit board is difficult. In the present embodiment, the first point light sources 130 and the second point light sources 150 are respectively disposed on the first circuit board 120 and the second circuit board 140. Therefore, the first point light sources 130 and the second point light sources 150 densely arranged are respectively disposed on different circuit boards (120 and 140), so that a problem of inadequate circuit layout spaces is avoided. In other words, a space p between the adjacent first point light source 130 and the second point light source 150 can be reduced or increased according to different design requirements, so that the light-emitting effect of the light source set 100 can fulfill different requirements.

According to the design of the present embodiment, besides that the first point light sources 130 and the second point light sources 150 can be densely arranged, the light source set 100 further has an advantage of thin and slim. Therefore, not only the light-emitting quality of the light source set 100 can match different design requirements, but also the light source set 100 can be widely applied to different products due to a thin design thereof. Moreover, in the present embodiment, the first circuit board 120 and the second circuit board 140 are respectively disposed on two opposite sides of the light cover 110, so that heat dissipation of conductive lines between the first circuit board 120 and the second circuit board 140 can be further improved. In other words, heat generated by the first point light sources 130 and the second point light sources 150 of the light source set 100 can be effectively dissipated, so as to achieve a longer lifespan of the point light sources.

Here, quantity of the first point light sources 130 equals to that of the second point light sources 150, though in other embodiment, the quantity of the first point light sources 130 can be greater than or less than that of the second point light sources 150. Namely, one or more second point light sources 150 can be disposed between two adjacent first point light sources 130, and even none of the second point light source 150 is disposed between a part of the two adjacent first point light sources 130.

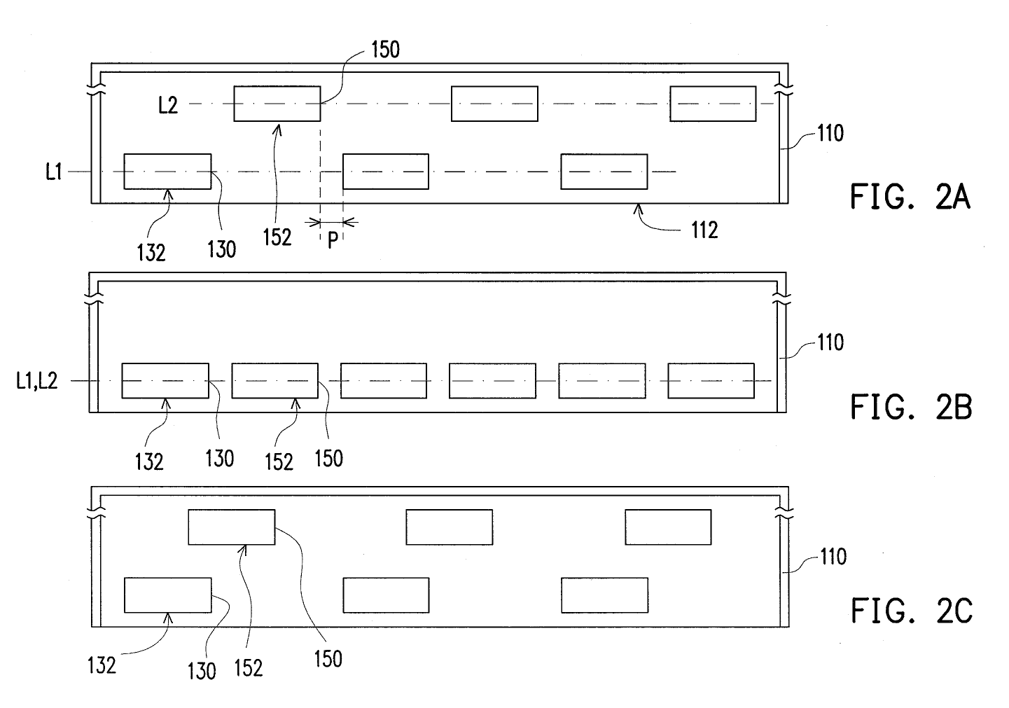

FIG. 2A and FIG. 2B are diagrams illustrating two configuration relations of first point light sources and second point light sources viewing from a first side to a second side of the light cover within the light source set of FIG. 1. FIG. 2C is a diagram illustrating a configuration relation of first point light sources and second point light sources viewing from a first side to a second side of the light cover within the light source set according to another embodiment of the present invention. Referring to both FIG. 1 and FIG. 2A, in the present embodiment, there is a space p between the first point light source 130 and the second point light source 150. Moreover, the first point light sources 130 are arranged along a first line L1, and the second point light sources 150 are arranged along a second line L2, wherein the first line L1 and the second line L2 are parallel to an extending direction of the first circuit board 120. Here, the first line L1 is located between the second line L2 and the opening 112. In other words, the first point light sources 130 and the second point light sources 150 are back and forth interlaced.

In FIG. 2B, the first line L1 is for example overlapped to the second line L2. Namely, the first point light sources 130 and the second point light sources 150 are densely arranged along a same straight line. Therefore, when the first point light sources 130 and the second point light sources 150 are simultaneously lighted, an approximate linear light source light-emitting effect is provided. Namely, in the present embodiment, distribution density of the first point light sources 130 and the second point light sources 150 is not limited by the circuit layout spaces. If one second point light source 150 is disposed between each two adjacent first point light sources 130, the distribution density of the point light sources then can be improved at least twice. Moreover, referring to FIG. 2C, in another embodiment, to achieve certain specific design requirements, besides the back and forth interlaced design, the first point light sources 130 and the second point light sources 150 can be partially overlapped. In a whole, the design of disposing location and distribution density of the first point light sources 130 and the second point light sources 150 of the present embodiment can be more flexible to satisfy different product requirements.

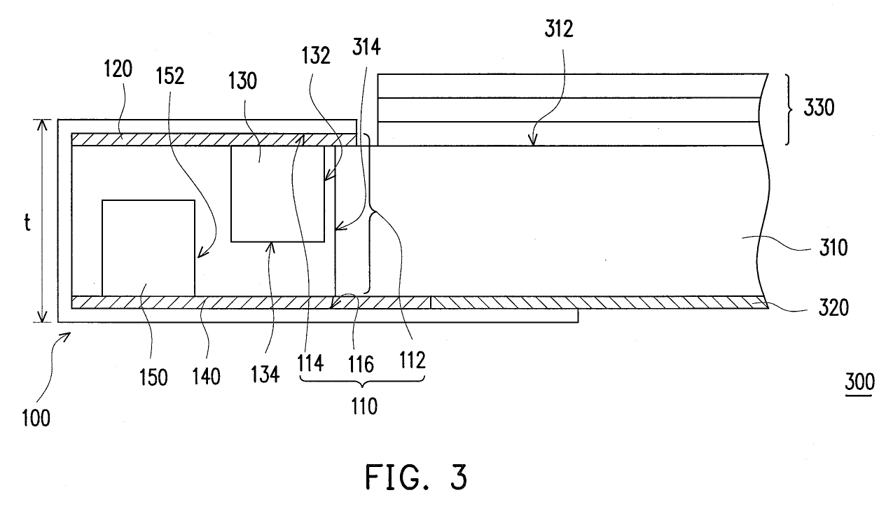

FIG. 3 is a cross-sectional view of a backlight module according to an embodiment of the present invention. Referring to FIG. 3, the backlight module 300 includes the aforementioned light source set 100, a light-guiding plate 310 and a reflecting plate 320. The light-guiding plate 310 is disposed aside the opening 112. The light-guiding plate 310 has a light-outlet surface 312 and a light-incident surface 314 located adjacent to the light-outlet surface 312, wherein the light-incident surface 314 faces the opening 112. The reflecting plate 320 is disposed on a side of the light-guiding plate 310 departing from the light-outlet surface 312. Since the light source set 100 is relatively thin, the backlight module 300 is thinned accordingly, so that the backlight module 300 can be more compact. Therefore, thickness of the light-guiding plate 310 is reduced, which avails saving a material cost of the light-guiding plate 310.

Moreover, the backlight module 300 further includes a plurality of optical films 330 disposed on the light-outlet surface 312, so that the backlight module 300 can provide a better light-emitting effect. The backlight module 300 can be utilized together with a display panel to form a display device. As the electronic products in the market trend to be thin and slim, the display devices are developed with a same trend. Therefore, a thin design of the backlight module 300 of the present embodiment can just satisfy such demand. Besides, the thin design of the present embodiment has no negative influence to the light-emitting effect and quality of the backlight module, so that the quality of the backlight module can be further improved.

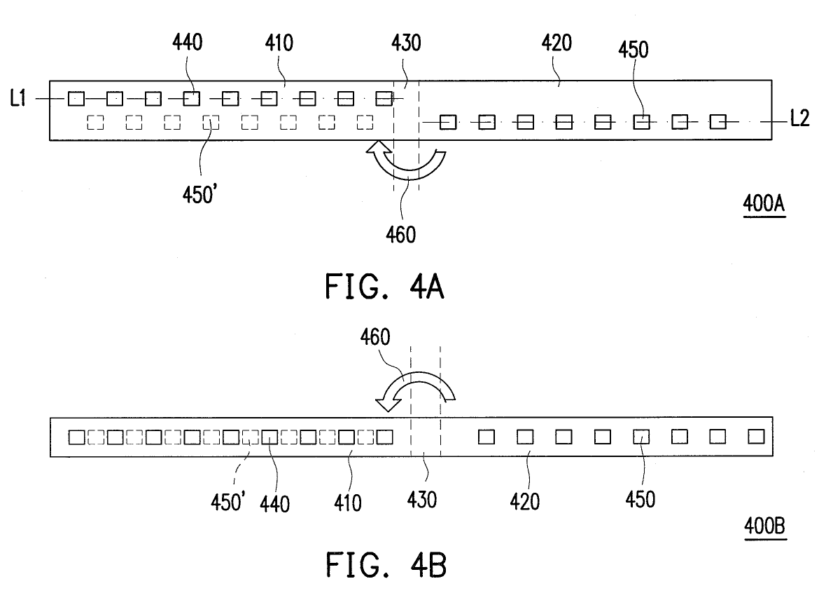

In the aforementioned embodiment, the first circuit board 120 and the second circuit board 140 are mutually independent. However, in other embodiments, the first circuit board 120 and the second circuit board 140 can be connected via a connecting circuit board. For example, the first circuit board 120 and the second circuit board 140 can be formed by bending a flexible circuit board into two opposite parts. FIG. 4A and FIG. 4B are schematic diagrams illustrating point light sources and a flexible circuit board according to an embodiment of the present invention. Referring to FIG. 4A, the circuit board 400A includes a first circuit board 410, a second circuit board 420 and a connecting circuit board 430. The first circuit board 410, the second circuit board 420 and the connecting circuit board 430 are integrally formed, and the connecting circuit board 430 is connected between the first circuit board 410 and the second circuit board 420. The first circuit board 410, the connecting circuit board 430 and the second circuit board 420 are designed to be a long bar in the present embodiment. Namely, when the design of the present embodiment is applied to the light source set 100 of FIG. 1, the connecting circuit board 430 is for example adjacent to the opening 112.

To be specific, in the present embodiment, a plurality of first point light sources 440 and a plurality of second point light sources 450 are respectively disposed on the first circuit board 410 and the second circuit board 420. On the circuit board 400A, the first point light sources 440 and the second point light sources 450 are, for example, respectively arranged along a first line L1 and a second line L2. The second circuit board 420 is bended towards the first circuit board 410 while taking the connecting circuit board 430 as a bending part, for example, bended towards a direction of an arrow 460. Then, the second point light sources 450 is for example, located at a position 450′. Now, the first point light sources 440 and the second point light sources 450 applied to the light source set 100 are for example, back and forth interlaced.

Referring to FIG. 4A and FIG. 4B, design of a circuit board 400B is similar to that of the circuit board 400A, and only a length-width ratio thereof is different. A plurality of the first point light sources 440 and a plurality of the second point light sources 450 are also respectively disposed on the first circuit board 410 and the second circuit board 420 of the circuit board 400B. Here, the first point light sources 440 and the second point light sources 450 are for example arranged along a same straight line. After the circuit board 400B is bended towards the direction of the arrow 460, the second point light sources 450 are for example located among the first point light sources 440, i.e. the position 450′.

After the circuit board 400A and the circuit board 400B are bended, the first point light sources 440 and the second point light sources 450 are located between the first circuit board 410 and the second circuit board 420. Namely, the first circuit board 410 and the second circuit board 420 are not physically touched, which avails to dissipate the heat generated on the circuit boards 400A and 400B. Therefore, such bending method can increase the distribution density of the first point light sources 440 and the second point light sources 450, and also has a good capability of heat dissipation, which avails improving the utilization lifespan of the first point light sources 440 and the second point light sources 450.

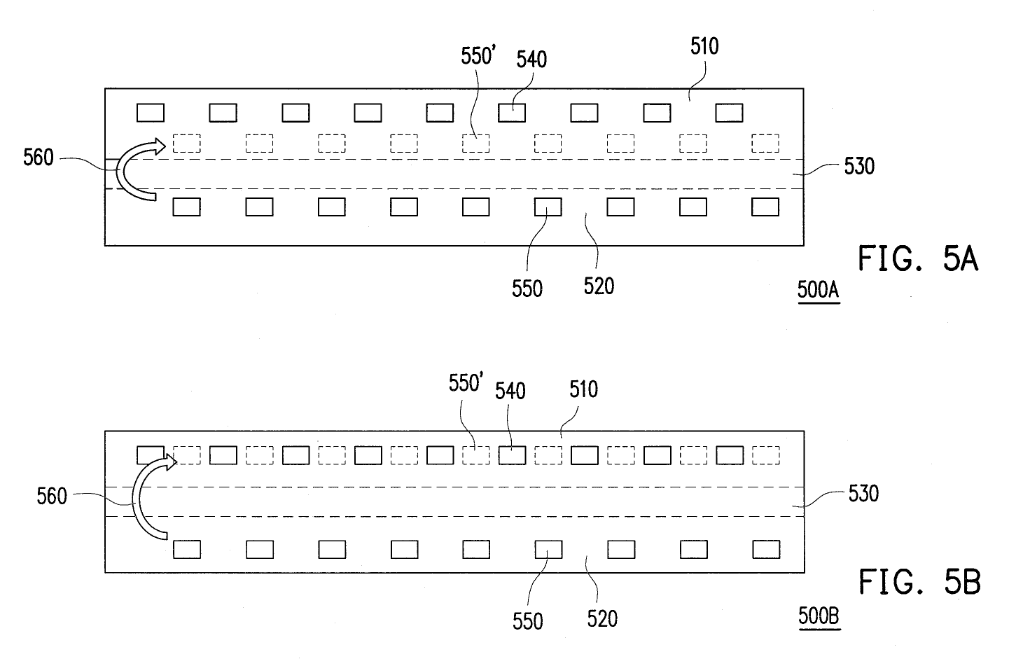

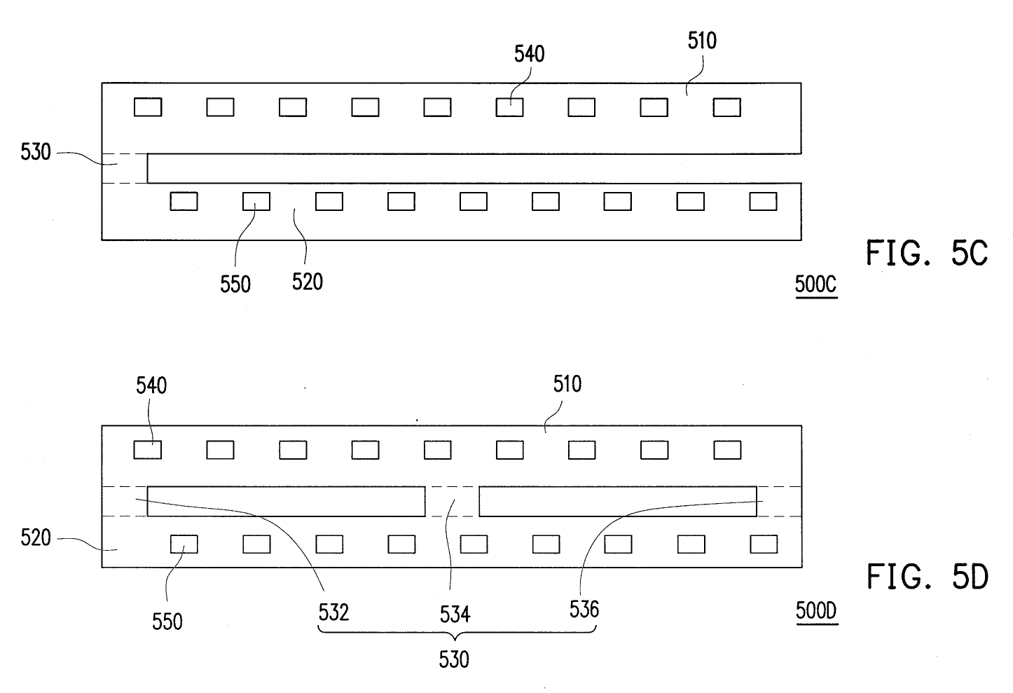

FIG. 5A and FIG. 5B are schematic diagrams illustrating point light sources and circuit boards according to another embodiment of the present invention. Referring to FIG. 5A, each of the circuit board 500A and the circuit board 500B includes a first circuit board 510, a second circuit board 520 and a connecting circuit board 530. The connecting circuit board 530 is connected between the first circuit board 510 and the second circuit board 520. When the circuit board 500A and the circuit board 500B are applied to the light source set 100 of FIG. 1, the connecting circuit board 530 is for example located opposite to the opening 112. Moreover, a width of the connecting circuit board 530 can be equal to that of the first circuit board 510 along an extending direction of the first circuit board 510. Namely, the circuit board 500A and the circuit board 500B are rectangular circuit boards.

To be specific, a plurality of first point light sources 540 is disposed on the first circuit board 510, and a plurality of second point light sources 550 is disposed on the second circuit board 520. In the circuit board 500A, a distance between the first point light sources 540 and an edge of the circuit board 500A is different to a distance between the second point light sources 550 and the edge of the circuit board 500A. When the circuit board 500A is bended towards a direction of an arrow 560 while taking the connecting circuit board 530 as the bending part, the second point light sources 550 is for example located at a position 550′. Namely, when the point light sources and the circuit boards of the present embodiment are assembled to the light cover to form a light source set, the first point light sources 540 and the second point light sources 550 are back and forth interlaced. The first point light sources 540 and the second point light sources 550 back and forth interlaced may be partially overlapped as that shown in FIG. 2C. Certainly, in other configuration methods, the first point light sources 540 and the second point light sources 550 can also be arranged in a straight line when being applied to the light source set, as that shown in FIG. 5B.

Moreover, FIG. 5C and FIG. 5D are schematic diagrams illustrating circuit boards and point light sources according to other embodiments of the present invention. Referring to FIG. 5C, the circuit board 500C is approximately the same to the aforementioned circuit board 500A, and a difference there between is only the width of the connecting circuit board 530. The width of the connecting circuit board 530 is less than that of the first circuit board 510 along the extending direction of the first circuit board 510. Therefore, when the circuit board 500C is assembled to the light cover 110 of FIG. 1A, a part of inner wall of the light cover 110 departing from the opening 112 can be exposed. Generally, the inner wall of the light cover 110 has a relatively high light reflectivity, and the circuit board 500C has a relatively low light reflectivity. Therefore, the design of the circuit board 500C is conducive to reflecting the light within the light cover 110 to the opening 112. In other words, the design of the circuit board 500C avails improving a light usage efficiency of the light source set 100.

Further, referring to FIG. 5D, in the circuit board 500D, to further improve a flexibility of the circuit layouts of the first circuit board 510 and the second circuit board 520, the connecting circuit board 530 includes a plurality of sub-connecting circuit boards 532, 534 and 536. A width of each of the sub-connecting circuit boards 532, 534 and 536 is less than that of the first circuit board 510 along the extending direction of the first circuit board 510. Each of the sub-connecting circuit boards 532, 534 and 536 may have a plurality of transmission lines for being coupled between the first circuit board 510 and the second circuit board 520. Namely, the circuit layout connected between the first circuit board 510 and the second circuit board 520 has at least three paths for selection, and therefore it can be more flexible.

In summary, in the present invention, two mutually independent circuit boards are disposed in opposite, or one circuit board is bended to form two opposite parts, and the point light sources are disposed on the two opposite circuit boards. Therefore, while guaranteeing adequate circuit layout spaces, the point light sources with high distribution density can be applied to the light source set and the backlight module of the present invention according to different usage requirements. Moreover, in the light source set and the backlight module of the present invention, the point light sources are disposed in interlace and are not mutually overlapped, which avails reducing the thickness of the light source set and the backlight module. Therefore, the light source set and backlight module of the present invention may have a thin and slim exterior. In the present invention, the circuit boards carrying the point light sources are disposed in opposite, which avails improving the heat dissipation efficiency of the point light sources. In overall, the light source and backlight module of the present invention at least has the advantages of thin, flexible light source configuration and long lifespan of the light source, etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light source set, comprising:
a light cover, having an opening, a first side and a second side, wherein the first side and the second side are located at two opposite sides of the opening;
a first circuit board, disposed on the first side;
a plurality of first point light sources, disposed on the first circuit board, and each first point light source having a first light-emitting surface facing to the opening and a first top surface departing from the first circuit board;
a second circuit board, disposed on the second side, and substantially parallel to the first circuit board; and
a plurality of second point light sources, disposed on the second circuit board, and each second point light source having a second light-emitting surface facing to the opening, wherein a distance between the first top surface and the second circuit board is smaller than a height of the second point light sources.

2. The light source set as claimed in claim 1, wherein the first point light sources are arranged along a first line, and the second point light sources are arranged along a second line, wherein the first line and the second line are parallel to an extending direction of the first circuit board.

3. The light source set as claimed in claim 2, wherein the first line is overlapped to the second line.

4. The light source set as claimed in claim 2, wherein the first line is located between the second line and the opening.

5. The light source set as claimed in claim 1, wherein quantity of the first point light sources is equal to that of the second point light sources.

6. The light source set as claimed in claim 1, wherein quantity of the first point light sources is greater than or less than that of the second point light sources.

7. The light source set as claimed in claim 1 further comprising a connecting circuit board connected between the first circuit board and the second circuit board.

8. The light source set as claimed in claim 7, wherein the first circuit board, the second circuit board and the connecting circuit board are integrally formed.

9. The light source set as claimed in claim 7, wherein the connecting circuit board is disposed adjacent to the opening.

10. The light source set as claimed in claim 7, wherein the connecting circuit board is disposed opposite to the opening.

11. The light source set as claimed in claim 10, wherein a width of the connecting circuit board is equal to that of the first circuit board along the extending direction of the first circuit board.

12. The light source set as claimed in claim 10, wherein a width of the connecting circuit board is less than that of the first circuit board along the extending direction of the first circuit board.

13. The light source set as claimed in claim 10, wherein the connecting circuit board comprises a plurality of sub-connecting circuit boards, and a width of each sub-connecting circuit board is less than that of the first circuit board along the extending direction of the first circuit board.

14. The light source set as claimed in claim 1, wherein the first point light sources and the second point light sources are a plurality of light-emitting diodes.

15. A backlight module, comprising:
a light source set, comprising:
a light cover, having an opening, a first side and a second side, wherein the first side and the second side are located at two opposite sides of the opening;
a first circuit board, disposed on the first side;
a plurality of first point light sources, disposed on the first circuit board, and each first point light source having a first light-emitting surface facing to the opening and a first top surface departing from the first circuit board;
a second circuit board, disposed on the second side, and substantially parallel to the first circuit board; and
a plurality of second point light sources, disposed on the second circuit board, and each second point light source having a second light-emitting surface facing to the opening, wherein a distance between the first top surface and the second circuit board is smaller than a height of the second point light sources;
a light-guiding plate, disposed aside the opening, and having a light-outlet surface and a light-incident surface located adjacent to the light-outlet surface, wherein the light-incident surface faces the opening; and
a reflecting plate, disposed on a side of the light-guiding plate departing from the light-outlet surface.

16. The backlight module as claimed in claim 15, wherein the first point light sources are arranged along a first line, and the second point light sources are arranged along a second line, wherein the first line and the second line are parallel to an extending direction of the first circuit board.

17. The backlight module as claimed in claim 16, wherein the first line is overlapped to the second line.

18. The backlight module as claimed in claim 16, wherein the first line is located between the second line and the opening.

19. The backlight module as claimed in claim 15, wherein quantity of the first point light sources is equal to that of the second point light sources.

20. The backlight module as claimed in claim 15, wherein quantity of the first point light sources is greater than or less than that of the second point light sources.

21. The backlight module as claimed in claim 15 further comprising a connecting circuit board connected between the first circuit board and the second circuit board.

22. The backlight module as claimed in claim 21, wherein the first circuit board, the second circuit board and the connecting circuit board are integrally formed.

23. The backlight module as claimed in claim 21, wherein the connecting circuit board is disposed adjacent to the opening.

24. The backlight module as claimed in claim 21, wherein the connecting circuit board is disposed opposite to the opening.

25. The backlight module as claimed in claim 24, wherein a width of the connecting circuit board is equal to that of the first circuit board along the extending direction of the first circuit board.

26. The backlight module as claimed in claim 24, wherein a width of the connecting circuit board is less than that of the first circuit board along the extending direction of the first circuit board.

27. The backlight module as claimed in claim 24, wherein the connecting circuit board comprises a plurality of sub-connecting circuit boards, and a width of each sub-connecting circuit board is less than that of the first circuit board along the extending direction of the first circuit board.

28. The backlight module as claimed in claim 15 further comprising a plurality of optical films disposed on the light-outlet surface of the light-guiding plate.

29. The backlight module as claimed in claim 15, wherein the first point light sources and the second point light sources are a plurality of light-emitting diodes.
